(19) United States
(12) Patent Application Publication
(10) Pub. No.: US 2011/0064161 A1
(43) Pub. Date: Mar. 17, 2011

(54) FREQUENCY SELECTIVE TRANSMISSION APPARATUS

(75) Inventors: In Gi LIM, Daejeon (KR); Sung Weon Kang, Daejeon (KR); Chang Hee Hyoung, Daejeon (KR); Hyung Il Park, Daejeon (KR); Jung Hwan Hwang, Daejeon (KR); Tae Wook Kang, Daejeon (KR); Kyung Soo Kim, Daejeon (KR); Jung Bum Kim, Daejeon (KR); Sung Eun Kim, Seoul (KR); Jin Kyung Kim, Daejeon (KR); Seok Bong Hyun, Daejeon (KR); Kyung Hwan Park, Daejeon (KR); Byoung Gun Choi, Daegu (KR); Tae Young Kang, Daejeon (KR)

(73) Assignee: Electronics and Telecommunications Research Institute, Daejeon (KR)

(21) Appl. No.: 12/854,142

(22) Filed: Aug. 10, 2010

(30) Foreign Application Priority Data
Sep. 14, 2009 (KR) 10-2009-0086544
Feb. 23, 2010 (KR) 10-2010-0016335

(51) Int. Cl. H04L 27/00

(52) U.S. Cl. 375/295

(57) ABSTRACT

There is provided a frequency selective transmission apparatus. The frequency selective transmission apparatus includes: a preamble generating unit that generates a preamble for frame synchronization; an SFD/RI generating unit that generates a start frame delimiter/rate indicator (SFD/RI) having a function of an indicator to announce the start of the frame and a function to define the transmission rates of a header field or header and data fields; a header generating unit that generates a header including attribute information on transmission data; a data generating unit that has a predetermined processing gain and transmits digital data at a desired frequency band; a pilot generating unit that generates a pilot inserted into the frame for frequency offset compensation; a multiplexer that receives and multiplexes outputs from the preamble generating unit, the SFD/RI generating unit, the header generating unit, the data generating unit, and the pilot generating unit, respectively; and a signal electrode that transmits the output from the multiplexer into a human body.

### CROSS-REFERENCE TO RELATED APPLICATIONS

This application claims the priorities of Korean Patent Application Nos. 10-2009-0086544 filed on Sep. 14, 2009 and 10-2010-0016335 filed on Feb. 23, 2010, in the Korean Intellectual Property Office, the disclosures of which are incorporated herein by reference.

### BACKGROUND OF THE INVENTION

1. Field of the Invention

The present invention relates to a frequency selective transmission apparatus, and more particularly, to a technology capable of proposing various types of frequency selective transmission apparatuses using a frequency selective spread code so as to avoid a frequency band in which noise power, more so than other bands, is concentrated around a human body and use a limited frequency band in which signal strength transmitted through a human body serving as a waveguide is larger than signal strength radiated to the outside of the human body, thereby making it possible to reduce the complexity of analog transmitting/receiving ends necessary to transmit a passband to reduce power consumption while obtaining a predetermined processing gain according to various transmission data rates and various applications.

2. Description of the Related Art

Korean Patent No. 829865 filed by the present inventor in 2006 and registered in 2008, entitled “System and Method for Human Body Communication using Limited Passband”, disclosed a system and a method for human body communication that use a limited passband from 5 MHz to 40 MHz in order to implement a system for human body communication and perform scrambling, channel coding, interleaving, spreading, and so on, using unique user identification information (ID).

In addition, Korean Patent No. 912543 filed in 2007 and registered in 2009, entitled “Apparatus and Method for Modulation and Demodulation using Frequency Selective Baseband”, disclosed a frequency selective multi-structure capable of improving a processing gain and a transmission data rate of an entire system by using serial-to-parallel conversion, frequency selective baseband transmission, and a limited number of spread codes.

However, the configuration of the transmission apparatus for transmitting data having various transmission data rates according to a defined frame construction and the configuration of the transmission apparatus for providing appropriate quality according to various applications have not been disclosed.

### SUMMARY OF THE INVENTION

An aspect of the present invention provides a frequency selective transmission apparatus implemented in various types and capable of reducing the complexity of analog transmitting/receiving ends necessary to transmit a passband to reduce power consumption while obtaining a predetermined processing gain according to various transmission data rates and various applications.

According to an aspect of the present invention, there is provided a frequency selective transmission apparatus, including: a preamble generating unit that generates a preamble for frame synchronization; an SFD/RI generating unit that generates a start frame delimiter/rate indicator (SFD/RI) having the function of an indicator to announce the start of the frame and a function to define the transmission rates of a header field or header and data fields; a header generating unit that generates a header including attribute information on transmission data; a data generating unit that has a predetermined processing gain and transmits digital data at a desired frequency band; a pilot generating unit that generates a pilot inserted into the frame for frequency offset compensation; a multiplexer that receives and multiplexes outputs from the preamble generating unit, the SFD/RI generating unit, the header generating unit, the data generating unit, and the pilot generating unit, respectively; and a signal electrode that transmits the output from the multiplexer into a human body.

According to another aspect of the present invention, there is provided a frequency selective transmission apparatus, comprising: a preamble generating unit that generates a preamble for frame synchronization; an SFD/RI generating unit that generates a start frame delimiter/rate indicator (SFD/RI) having a function of an indicator to announce the start of the frame and a function to define the transmission rates of header/data fields; a header/data generating unit that transmits a header and data having a predetermined processing gain at the desired frequency band by spreading the header and the data including attribute information on transmission data in the same manner; a pilot generating unit that generates a pilot inserted into the frame for frequency offset compensation; a first multiplexer that receives and multiplexes outputs from the preamble generating unit, the SFD/RI generating unit, the header/data generating unit, and the pilot generating unit, respectively; and a signal electrode that transmits the output from the first multiplexer into a human body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing a frame construction according to an exemplary embodiment of the present invention;

FIG. 2 is diagram showing a sub group construction of 64-bit Walsh codes according to an exemplary embodiment of the present invention;

FIGS. 3A through 3D are diagrams showing available frequency bands based on the selection of frequency selective spread codes according to an exemplary embodiment of the present invention;

FIG. 4 is a configuration diagram of a frequency selective transmission apparatus according to a first exemplary embodiment of the present invention;

FIG. 5 is a detailed configuration diagram of a data generating unit according to a first exemplary embodiment of the present invention;

FIG. 6 is a configuration diagram of a frequency selective transmission apparatus according to a second exemplary embodiment of the present invention;

FIG. 7 is a configuration diagram of a frequency selective transmission apparatus according to a third exemplary embodiment of the present invention;

FIGS. 8A through 8D are detailed configuration diagrams of a data generating unit according to a third exemplary embodiment of the present invention; and

FIG. 9 is a configuration diagram of a frequency selective transmission apparatus according to a fourth exemplary embodiment of the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail. In addition, like reference numerals denote parts performing similar functions and actions throughout the drawings.

Throughout this specification, when it is described that an element is “connected” to another element, the element may be “directly connected” to another element or “indirectly connected” to another element through a third element. In addition, unless explicitly described otherwise, “comprising” any components will be understood to imply the inclusion of other components but not the exclusion of any other components.

A transmission apparatus disclosed in the exemplary embodiments of the present invention uses frequency selective digital transmission (FSDT). The frequency selective digital transmission spreads data in a frequency domain by using a frequency selective spread code and then transmits it in digital form. Further, a dominant frequency in which most transmission signals are distributed may be selected by using the specific frequency selective spread code.

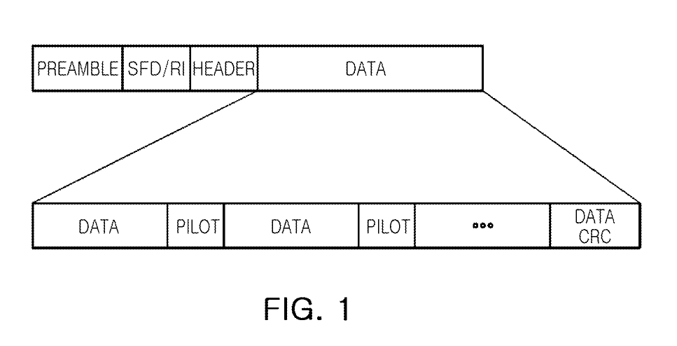

FIG. 1 is a diagram showing a frame construction according to an exemplary embodiment of the present invention.

Referring to FIG. 1, a frame transmitted through a frequency selective transmission apparatus according to an exemplary embodiment of the present invention is configured to include a preamble, a start frame delimiter/rate indicator (SFD/RI), a header, and a data field, wherein the data field has a construction such that a pilot having a predetermined length is inserted into data transmitted according to a defined time interval and a data cyclic redundancy check (CRC) for determining the validity of the data field is inserted into an end of the data field.

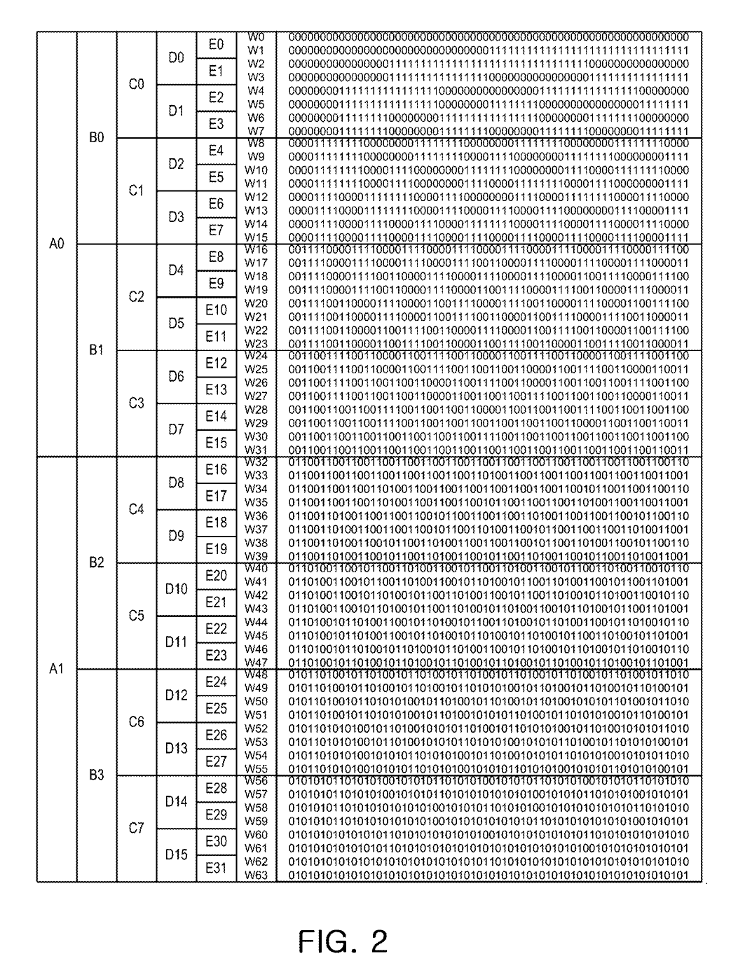

FIG. 2 is diagram showing a sub group of 64-bit Walsh codes according to an exemplary embodiment of the present invention.

Referring to FIG. 2, the 64 Walsh codes from W₀ to W₆₃ accurately divide available frequency bands into 64 and sequentially map the most dominant frequency fd of each Walsh code to the divided frequencies.

The 64 Walsh codes may be divided into one or more sub-groups. For example, when selecting 32 Walsh codes of 64 Walsh codes and using them as the frequency selective spread code, the 64 Walsh codes are divided into two sub-groups of A0 and A1. Similarly, when selecting 16 Walsh codes and using them, the 64 Walsh codes are divided into four sub-groups of B0 to B3, when selecting 8 Walsh codes and using them, the 64 Walsh codes are divided into 8 sub-groups of C0 to C7, when selecting 4 Walsh codes and using them, the 64 Walsh codes are divided into 16 sub-groups of D0 to D15, and when selecting 2 Walsh codes and using them, the 64 Walsh codes are divided into 32 sub-groups of E0 to E31. A user or a designer can select the desired frequency bands by selecting and using any one of the divided sub-groups as described above.

However, the number of Walsh codes and the number of sub-groups are not limited thereto. A total of 2^{N} (N is real number) Walsh codes are divided into 2^{M} (M is real number, M<N) to generate the sub-groups, thereby making it possible to select and use any one of the sub-groups.

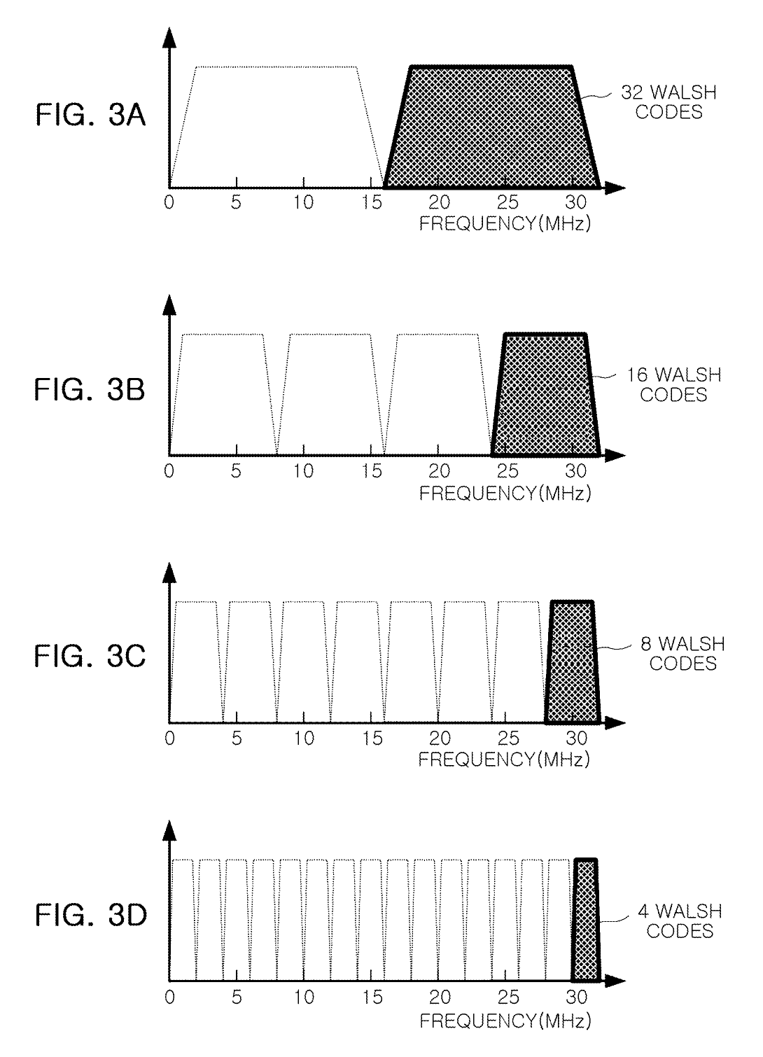

FIGS. 3A through 3D are diagrams showing the available frequency bands based on the selection of the frequency selective spread codes according to an exemplary embodiment of the present invention. It is assumed that the following exemplary embodiments use the 64 Walsh codes as shown in FIG. 2 as the frequency selective spread codes clock and use a 64 MHz.

FIG. 3A shows the case in which the A1 sub-group shown in FIG. 2 is selected. The transmission data is mapped to one of 32 Walsh codes W32 to W63 having dominant frequency components at 16 MHz to 32 MHz that are the user's or designer's desired frequency bands, such that 64 bits are output in 1 bit stream form.

FIG. 3B shows the case in which the B3 sub-group shown in FIG. 2 is selected. The transmission data is mapped to one of 16 Walsh codes W48 to W63 having dominant frequency component at 24 MHz to 32 MHz that are the user's or designer's desired frequency bands, such that 64 bits are output in 1 bit stream form.

FIG. 3C shows the case in which the C7 sub-group shown in FIG. 2 is selected. The transmission data is mapped to one of 8 Walsh codes W56 to W63 having dominant frequency component at 28 MHz to 32 MHz that are the user's or designer's desired frequency bands, such that 64 bits are output in 1 bit stream form.

FIG. 3D shows the case in which the D15 sub-group shown in FIG. 2 is selected. The transmission data is mapped to one of 4 Walsh codes W60 to W63 having dominant frequency component at 30 MHz to 32 MHz that are the user's or designer's desired frequency bands, such that 64 bits are output in 1 bit stream form.

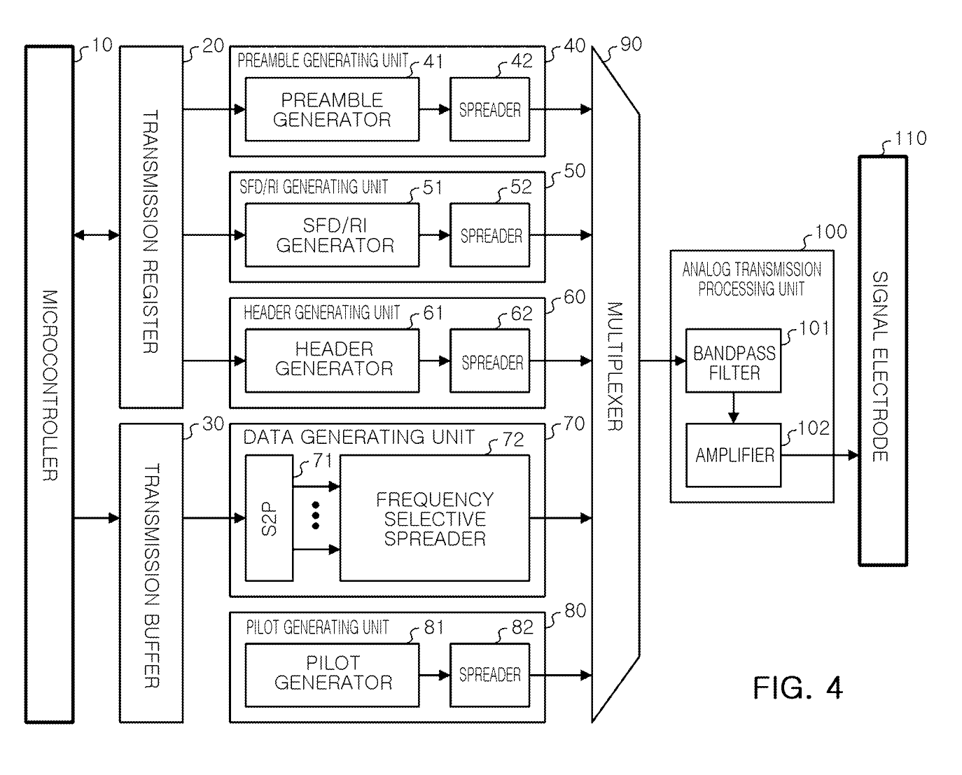

A configuration of the frequency selective transmission apparatus according to various exemplary embodiments of the present invention will now be described with reference to FIGS. 4 to 9. For convenience of explanation, it is assumed that the following exemplary embodiments transmit a frame including a preamble, an SFD/RI, a header, and data as shown in FIG. 1, use the 64 Walsh codes as the frequency selective spread codes as shown in FIG. 2, select and use each of the upper 32, 16, 8, and 4 Walsh codes of the 64 Walsh codes as shown in FIGS. 3A to 3D, and use the 64 MHz clock.

FIG. 4 is a configuration diagram of a frequency selective transmission apparatus according to a first embodiment of the present invention.

A frequency selective transmission apparatus according to a first embodiment is configured to include a microcontroller 10, a transmission register 20, a transmission buffer 30, a preamble generating unit 40, an SFD/RI generating unit 50, a header generating unit 60, a data generating unit 70, a pilot generating unit 80, a multiplexer 90, an analog transmission processing unit 100, and a signal electrode 110.

The microcontroller 10 processes transmission data and data information received from an upper layer, wherein the data information is transmitted to the transmission register 20 and the transmission data is transmitted to the transmission buffer 30.

The transmission register 20 inputs the data information transmitted from the microcontroller 10, that is, a preamble construction value, an SFD/RI control value, and attribute information on the transmission data to the preamble generating unit 40, the SFD/RI generating unit 50, and the header generating unit 60, respectively.

The transmission buffer 30 stores the transmission data transmitted from the microcontroller 10 and inputs the corresponding transmission data into the data generating unit 70 at each defined time for each frame.

The preamble generating unit 40, which is for generating a preamble positioned at a start of each frame for frame synchronization, is configured to include a preamble generator 41 and a spreader 42. The preamble generator 41 may generate the preamble configured of, for example, pseudo noise codes or a repeated combination of the pseudo noise codes. The spreader 42 spreads the preamble generated from the preamble generator 41. The spreader 42, which spreads the preamble into the desired frequency band while possibly maintaining the unique correlation characteristics of the preambles, may use any one of the Walsh codes shown in FIG. 2 or use a combination of a Walsh code and a line code, such as Manchester code, which is for improving the correlation characteristic.

The SFD/RI generating unit 50, which generates the SFD/RI that has a function of being an indicator to announce the start of the frame and a function to define the transmission rates of a header field or header and data fields, is configured to include an SFD/RI generator 51 and a spreader 52. The SFD/RI generator 51 may use the same pseudo noise code as that of the preamble generator 41 or the pseudo noise code different from that of the preamble generator 41 and may determine the transmission rates of the header field or the header and data fields following the SFD/RI by assigning a time offset to the start of the pseudo noise code. The spreader 52, which spreads the SFD/RI generated from the SFD/RI generator 51 to the desired frequency band, may use, for example, any one of the Walsh codes shown in FIG. 2.

The header generating unit 60, which generates the header including the attribute information on the transmission data, is configured to include a header generator 61 and a spreader 62. The header generator 61 generates the header including an input value from the transmission register 20 and preset control bits and having the predetermined number of bits. At this time, when the SFD/RI generated from the SFD/RI generator 51 defines only the transmission rate of the header, the header includes information on the transmission rate of the data or when the SFD/RI generated from the SFD/RI generator 51 defines all of the transmission rates of the header and the data, the header may not include separate information on the transmission rate of the data. The spreader 62 spreads the header generated from the header generator 61 to the desired frequency band, and may use, for example, any one of the Walsh codes shown in FIG. 2.

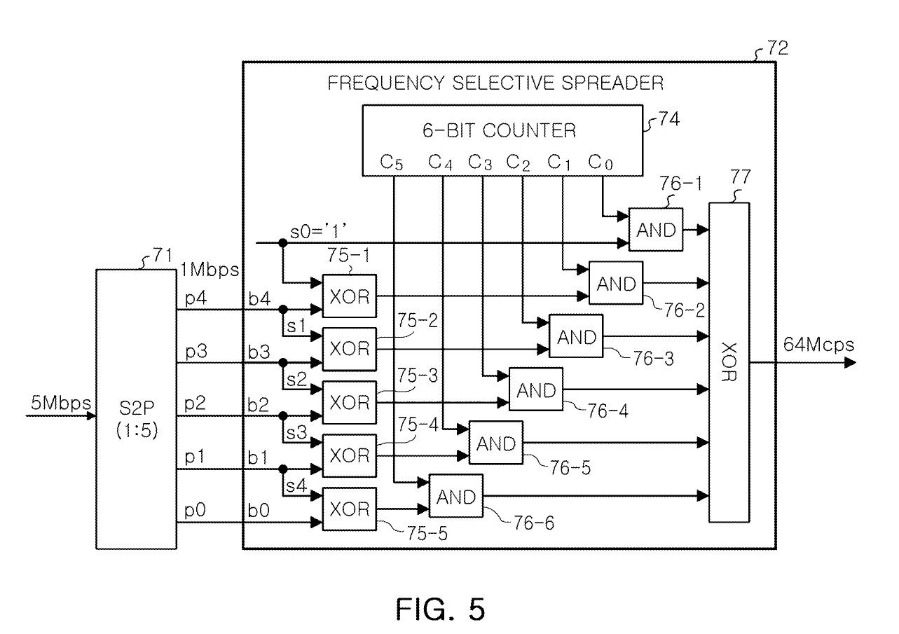

The data generating unit 70 transmits digital data having a predetermined processing gain at the user's or designer's desired frequency band and is configured to include a serial-to-parallel converter (S2P) 71 and a frequency selective spreader 72. The S2P 71 performs serial-to-parallel conversion on the transmission data input from the transmission buffer 30 according to the transmission rate of the data and converts it into N bits. For example, as shown in FIG. 3A, when selecting 32 Walsh codes of the 64. Walsh codes, N is 5, as shown in FIG. 3B, when selecting 16 Walsh codes of the 64 Walsh codes, N is 4, as shown in FIG. 3C, when selecting 8 Walsh codes of the 64 Walsh codes, N is 3, and as shown in FIG. 3D, and when selecting 4 Walsh codes of the 64 Walsh codes, N is 2. The frequency selective spreader 72 spreads the transmission data that are serial-to-parallel converted by the S2P 71 using the frequency selective spread codes positioned in the desired frequency band. The detailed configuration of the frequency selective spreader 72 will be described below with reference to FIG. 5. As described above, the output bit of the data generating unit 70 is 1 bit, which can be directly transmitted digitally. Therefore, the output of the data generating unit 70 may be transmitted by being directly input to the signal electrode 110 without performing the separate analog transmission processes such as a digital-to-analog converter, an intermediate frequency converter, and the like.

The pilot generating unit 80, which generates the pilot inserted into the frame to be transmitted so as to compensate for the frequency offset with a transmitting end at a receiving end, is configured to include a pilot generator 81 and a spreader 82. The pilot generator 81 may use a portion of, or all of the preambles generated from the preamble generator 41 as the pilot or may generate the pilot having a predetermined length and the same construction as the preamble and output values different from the preamble by using a different initial value. The spreader 82, which spreads the pilot generated from the pilot generator 81 to the desired frequency band, may use, for example, any one of the Walsh codes shown in FIG. 2.

The multiplexer 90 receives outputs from the preamble generating unit 40, the SFD/RI generating unit 50, the header generating unit 60, the data generating unit 70, and the pilot generating unit 80, respectively, and multiplexes them and outputs the frame constructed as shown in FIG. 1 as a digital signal in a 1-bit form.

The analog transmission processing unit 100 may be selectively provided according to the applications of the transmission apparatus, if necessary. The analog transmission processing unit 100 may be configured to include at least any one of a bandpass filter 101 that increases the limits on the desired frequency band and an amplifier 102 that amplifies the final output signals.

The signal electrode 110, which transmits an output from the multiplier 90 or the analog transmission processing unit 100 into a human body, may be implemented as a contact based electrode or a non-contact based electrode or an antenna structure.

FIG. 5 is a detailed configuration diagram of a data generating unit according to the first exemplary embodiment of the present invention.

A data generating unit according to a first exemplary embodiment of the present invention is configured to include the S2P 71 and the frequency selective spreader 72 and the frequency selective spreader 72 is configured to include a 6-bit counter 74 that is reset to an initial value for each symbol period, 5 XOR logic circuits 75-1 to 75-5 that perform Gray indexing, 6 AND logic circuits 76-1 to 76-6 that use outputs C₅ to C₀ from the 6-bit counter 74, an input bit s0, and output bits from the 5 XOR logic circuits 75-1 to 75-5, respectively, as inputs, and an XOR logic circuit 77 that performs an XOR on the outputs from 6 AND logic circuits 76-1 to 76-6. The frequency selective spreader 72 has 6 input bits (s0, b4=s1, b3=s2, b2=s3, b1=s4, b0).

The operation of the data generating unit will be described by way of example. As shown in FIG. 3A, when the A1 sub-group shown in FIG. 2 is selected, the S2P 71 receives 1-bit data of 5 Mbps and outputs 5-bit parallel data p4 to p0 of 1 Mbps. When the input bit s0 controlling the frequency selection is set to ‘1’ and the 5 output bits p4 to p0 from the S2P 71 are sequentially input to b4 to b0, the frequency selective spreader 72 generates one of the 32 Walsh codes W32 to W63 according to the values of the input bits b4 to b0 and outputs 64 bits in a 1 bit stream form at a speed of 64 Mcps.

As shown in FIG. 3B, when the B3 sub-group shown in FIG. 2 is selected, the S2P 71 receives 1-bit data of 4 Mbps and outputs 4-bit parallel data p3 to p0 of 1 Mbps. When each input bit s0 and s1 controlling the frequency selection is set to ‘1’ and the 4 output bits p3 to p0 from the S2P 71 are sequentially input to b3 to b0, the frequency selective spreader 72 generates one of the 16 Walsh codes W48 to W63 according to the values of the input bits b3 to b0 and outputs 64 bits in a 1 bit stream form at a speed of 64 Mcps.

As shown in FIG. 3C, when the C7 sub-group shown in FIG. 2 is selected, the S2P 71 receives 1-bit data of 3 Mbps and outputs 3-bit parallel data p2 to p0 of 1 Mbps. When each input bit s0, s1, and s2 controlling the frequency selection is set to ‘1’ and the 3 output bits p2 to p0 from the S2P 71 are sequentially input to b2 to b0, the frequency selective spreader 72 generates one of the 8 Walsh codes W56 to W63 according to the values of the input bits b2 to b0 and outputs 64 bits in a 1 bit stream form at a speed of 64 Mcps.

As shown in FIG. 3D, when the D15 sub-group shown in FIG. 2 is selected, the S2P 71 receives 1-bit data of 2 Mbps and outputs 2-bit parallel data p1 and p0 of 1 Mbps. When each input bit s0, s1, s2, and s3 controlling the frequency selection is set to ‘1’ and the 2 output bits p1 and p0 from the S2P 71 are sequentially input to b1 and b0, the frequency selective spreader 72 generates one of the 4 Walsh codes W60 to W63 according to the values of the input bits b1 and b0 and outputs 64 bits in a 1 bit stream form at a speed of 64 Mcps.

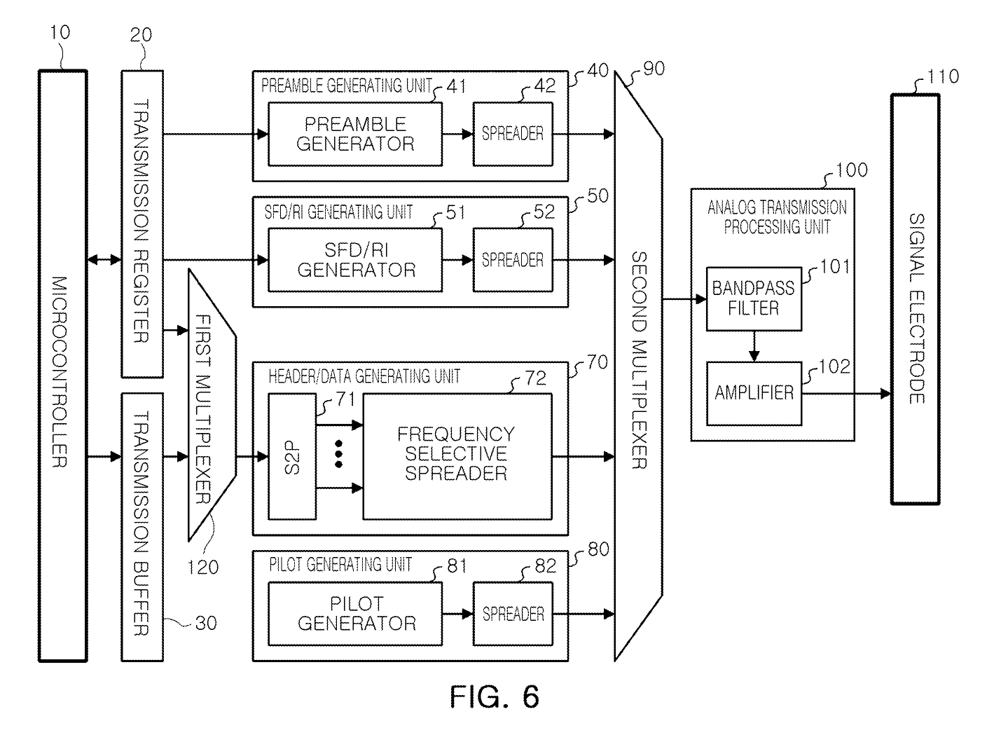

FIG. 6 is a configuration diagram of a frequency selective transmission apparatus according to a second exemplary embodiment of the present invention.

A frequency selective transmission apparatus according to a second exemplary embodiment is configured to include the microcontroller 10, the transmission register 20, the transmission buffer 30, the preamble generating unit 40, the SFD/RI generating unit 50, the header/data generating unit 70, the pilot generating unit 80, first and second multiplexers 120 and 90, the analog transmission processing unit 100, and the signal electrode 110.

The frequency selective transmission apparatus according to the second exemplary embodiment is different from the frequency selective transmission apparatus according to the first exemplary embodiment in that when generating the header, it does not spread the header using one spread code but spread the header though the S2P and the frequency selective spreader similar to the data.

Specifically, the frequency selective transmission apparatus according to the second embodiment further includes the first multiplexer 120, wherein the transmission register 20 inputs the attribute information on the transmission data among the data information transmitted from the microcontroller 10 to the first multiplexer 120, the transmission buffer 30 stores the transmission data transmitted from the microcontroller 10 and inputs the corresponding transmission data to the first multiplexer 120 at each defined time for each frame, and the first multiplexer 120 multiplexes the attribute information on the input transmission data and the transmission data and inputs it to the header/data generating unit 70. The header/data generating unit 70 spreads the header and the data according to the frequency selective spread scheme, as in the data generating unit of the first exemplary embodiment. The remaining components are the same as each component of the frequency selective transmission apparatus according to the first exemplary embodiment and therefore, a detailed description thereof will be omitted.

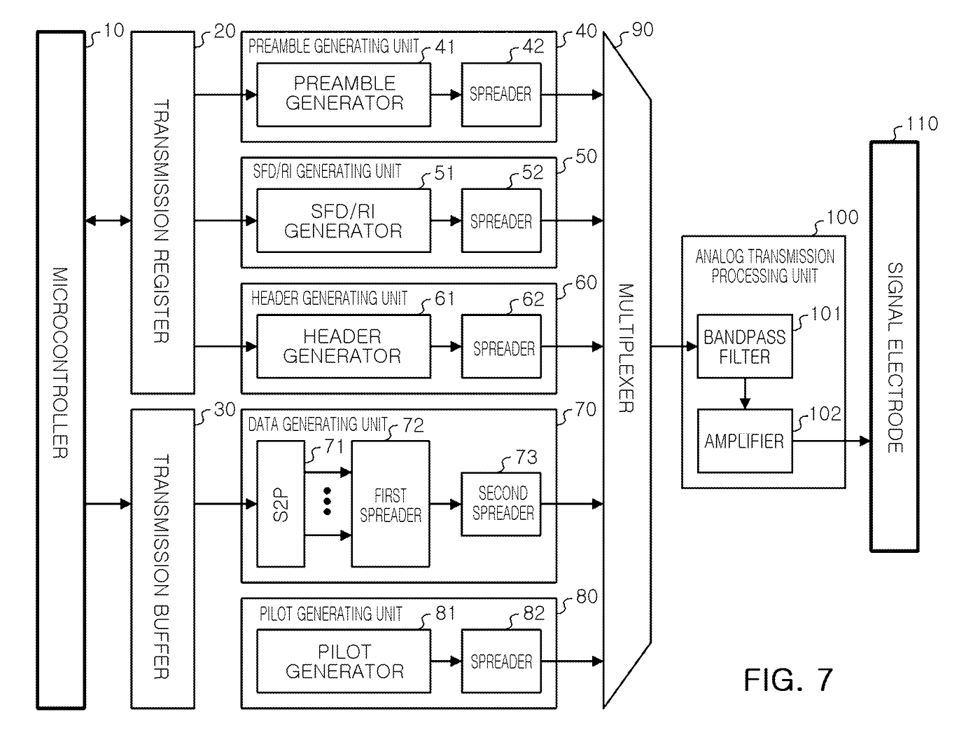

FIG. 7 is a configuration diagram of a frequency selective transmission apparatus according to a third exemplary embodiment of the present invention.

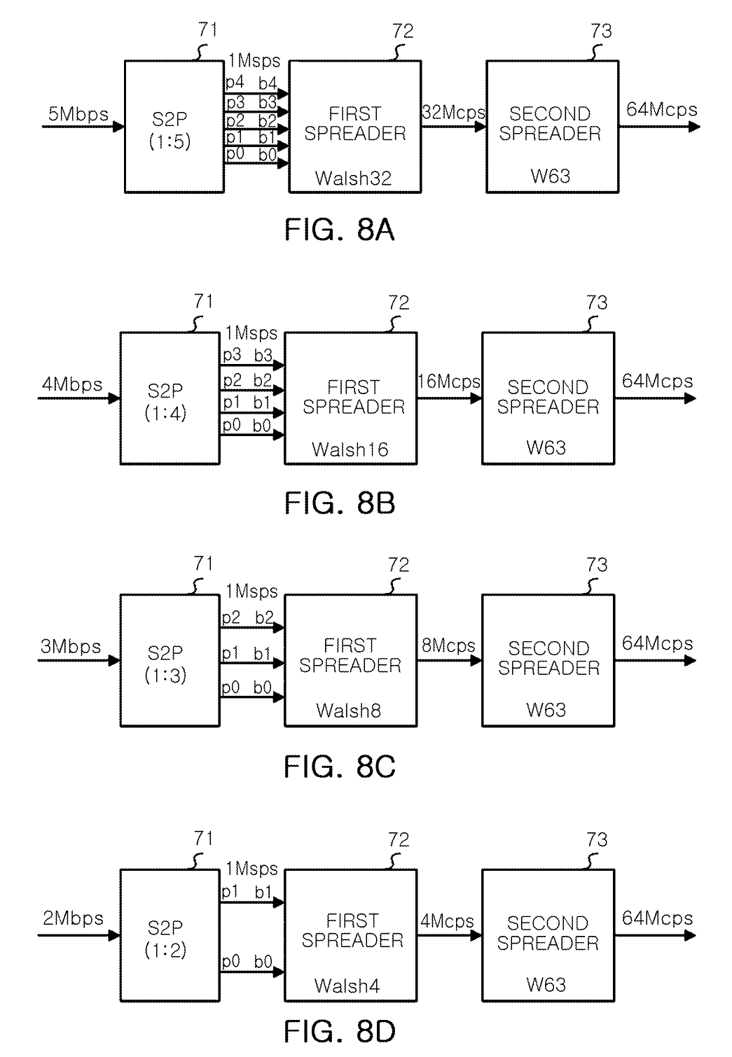

A frequency selective transmission apparatus according to a third embodiment is configured to include the microcontroller 10, the transmission register 20, the transmission buffer 30, the preamble generating unit 40, the SFD/RI generating unit 50, the header generating unit 60, the data generating unit 70, the pilot generating unit 80, the multiplexer 90, the analog transmission processing unit 100, and the signal electrode 110, similar to the frequency selective transmission apparatus according to the first exemplary embodiment. However, the frequency selective transmission apparatus according to the third embodiment is different from frequency selective transmission apparatus according to the first exemplary embodiment in that the data generating unit 70 is configured to include the S2P 71, the first spreader 72 and the second spreader 73 while the remaining components thereof are the same as those of the first exemplary embodiment. Therefore, only the detailed components of the data generating unit 70 will be described with reference to FIGS. 8A through 8D.

FIGS. 8A through 8D are detailed configuration diagrams of a data generating unit according to a third exemplary embodiment of the present invention.

The data generating unit 70 according to the third exemplary embodiment is configured to include the S2P 71, the first spreader 72, and the second spreader 73. The S2P 71 receives 1-bit data input from the transmission buffer 30 and performs the serial-to-parallel conversion on the received 1-bit input according to the data transmission rate of the data and converts and outputs it into N bits. The first spreader 72 receives and spreads the output N bits from the S2P 72 and uses different spread codes according to the data transmission rate. The second spreader 73 spreads outputs from the other first spreader 72 using one spread code.

The operation of the data generating unit will be described in detail by way of example. As shown in FIG. 8A, the S2P 71 receives 1-bit data of 5 Mbps and outputs 5-bit parallel data p4 to p0 of 1 Mbps. The first spreader 72 generates the 32-bit Walsh codes and selects one of 32 number of 32-bit Walsh codes W0 to W31 according to the values of the input bits b4 to b0 and outputs 32 bits in a 1 bit stream form at a speed of 32 Mcps. The second spreader 73 re-spreads an output from the first spreader 72 twice by using W63, such that it selects one of the 32 Walsh codes W32 to W63 that are the A1 sub-group of FIG. 2, thereby outputting 64 bits in a 1 bit stream form at a speed of 64 Mcps.

As shown in FIG. 8B, the S2P 71 receives 1-bit data of 4 Mbps and outputs 4-bit parallel data p3 to p0 of 1 Mbps. The first spreader 72 generates the 16-bit Walsh codes and selects one of 16 number of 16-bit Walsh codes W0 to W15 according to the values of the input bits b3 to b0, thereby outputting 16 bits in a 1 bit stream form at a speed of 16 Mcps. The second spreader 73 re-spreads an output from the first spreader 72 four times by using W63, such that it selects one of the 16 Walsh codes W48 to W63 that are the B3 sub-group of FIG. 2, thereby outputting 64 bits in a 1 bit stream form at a speed of 64 Mcps.

As shown in FIG. 8C, the S2P 71 receives 1-bit data of 3 Mbps and outputs 3-bit parallel data p2 to p0 of 1 Mbps. The first spreader 72 generates the 8-bit Walsh codes and selects one of 8 number of 8-bit Walsh codes W0 to W7 according to the values of the input bits b2 to b0, thereby outputting 8 bits in a 1 bit stream form at a speed of 8 Mcps. The second spreader 73 re-spreads an output from the first spreader 72 eight times by using W63, such that it selects one of the 8 Walsh codes W56 to W63 that are the C7 sub-group of FIG. 2, thereby outputting 64 bits in a 1 bit stream form at a speed of 64 Mcps.

As shown in FIG. 8D, the S2P 71 receives 1-bit data of 2 Mbps and outputs 2-bit parallel data p1 and p0 of 1 Mbps. The first spreader 72 generates the 4-bit Walsh codes and selects one of 4 number of 4-bit Walsh codes W0 to W3 according to the values of the input bits b1 and b0, thereby outputting 4 bits in a 1 bit stream form at a speed of 4 Mcps. The second spreader 73 re-spreads an output from the first spreader 72 sixteen times by using W63, such that it selects one of the 4 Walsh codes W60 to W63 that are the D15 sub-group of FIG. 2, thereby outputting 64 bits in a 1 bit stream form at a speed of 64 Mcps.

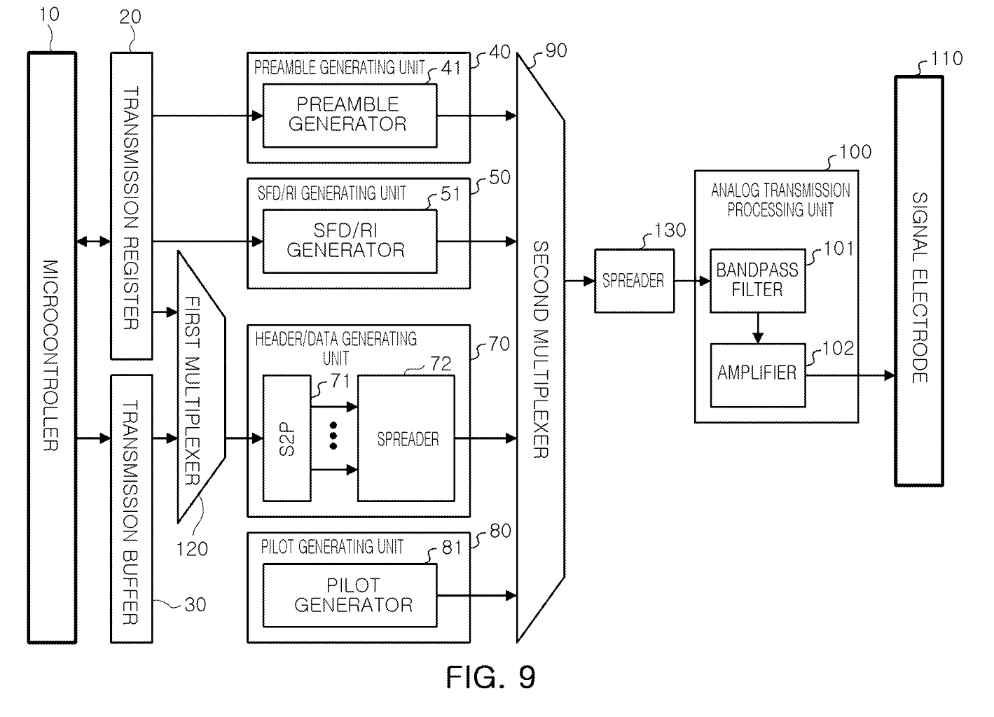

FIG. 9 is a configuration diagram of a frequency selective transmission apparatus according to a fourth exemplary embodiment of the present invention.

A frequency selective transmission apparatus according to a fourth exemplary embodiment is configured to include the microcontroller 10, the transmission register 20, the transmission buffer 30, the preamble generating unit 40, the SFD/RI generating unit 50, the header/data generating unit 70, the pilot generating unit 80, the first and second multiplexers 120 and 90, a spreader 130, the analog transmission processing unit 100, and the signal electrode 110.

The frequency selective transmission apparatus according to the fourth embodiment includes the first multiplexer 120 in order to spread the header and the data by using the same spread scheme as the second exemplary embodiment. The frequency selective transmission apparatus according to the fourth embodiment is different from the above-mentioned exemplary embodiments in that it replaces the spreaders (the second spreader in the data generator) included in the preamble generating unit, the SFD/RI generating unit, the data generating unit, and the pilot generating unit, respectively, with a single spreader 130 connected to the output end of the second multiplexer 90.

The spreader 130 connected to the output end of the second multiplexer 90 uses a single spreading code, for example, W63, to spread the output of the second multiplexer 90.

As set forth above, the present invention selectively uses the analog transmission processing unit according to various applications at the time of transmitting the data having various transmission data rates according to the defined frame construction, thereby making it possible to obtain the predetermined processing gain at the desired frequency band only by using the digital signal or the amplified analog signal having the limited band, maintain the applications at the optimized high quality, simplify the implementation thereof, and reduce the circuit complexity and the power consumption.

While the present invention has been shown and described in connection with the exemplary embodiments, it will be apparent to those skilled in the art that modifications and variations can be made without departing from the spirit and scope of the invention as defined by the appended claims.

What is claimed is:

1. A frequency selective transmission apparatus, comprising:
a preamble generating unit that generates a preamble for frame synchronization;
an SFD/RI generating unit that generates a start frame delimiter/rate indicator (SFD/RI) having a function of an indicator to announce the start of the frame and a function to define the transmission rates of a header field or header and data fields;
a header generating unit that generates a header including attribute information on transmission data;
a data generating unit that has a predetermined processing gain and transmits digital data at a desired frequency band;
a pilot generating unit that generates a pilot inserted into the frame for frequency offset compensation;
a multiplexer that receives and multiplexes outputs from the preamble generating unit, the SFD/RI generating unit, the header generating unit, the data generating unit, and the pilot generating unit, respectively; and
a signal electrode that transmits the output from the multiplexer into a human body.

2. The frequency selective transmission apparatus of claim 1, further comprising:
a transmission register that inputs a preamble construction value, an SFD/RI control value, and attribute information on the transmission data among data information transmitted from an upper layer, respectively, to the preamble generating unit, the SFD/RI generating unit, and the header generating unit; and
a transmission buffer that stores the transmission data transmitted from the upper layer and then inputs the transmission data into the data generating unit at a predetermined time for each frame.

3. The frequency selective transmission apparatus of claim 1, further comprising an analog transmission processing unit that is connected to the output end of the multiplexer, including at least one of a bandpass filter that limits the output from the multiplexer to the desired frequency band and an amplifier that amplifies a final output signal.

4. The frequency selective transmission apparatus of claim 1, wherein the preamble generating unit includes:
a preamble generator that generates a preamble configured of pseudo noise codes or a repeated combination of the pseudo noise codes; and
a spreader that spreads a preamble generated from the preamble generator.

5. The frequency selective transmission apparatus of claim 1, wherein the SFD/RI generating unit includes:
an SFD/RI generator that generates the SFD/RI using the same pseudo noise code as that of the preamble generating unit or the pseudo noise code different from that of the preamble generating unit and defining the transmission rates of the header field or the header and data fields by assigning a time offset to the start of the pseudo noise code; and
a spreader that spreads the SFD/RI generated from the SFD/RI generator.

6. The frequency selective transmission apparatus of claim 2, wherein the header generating unit includes:
a header generator generating a header that includes attribute information on the transmission data transmitted from the transmission register and the predetermined control bit; and
a spreader that spreads a header generated from the header generator.

7. The frequency selective transmission apparatus of claim 2, wherein the data generating unit includes:
a serial-to-parallel converter that performs serial-to-parallel conversion on the transmission data transmitted from the transmission buffer according to the data transmission rate and converts them into N bits; and
a frequency selective spreader that spreads the transmission data serial-to-parallel converted by the serial-to-parallel converter using frequency selective spread codes positioned in the desired frequency band.

8. The frequency selective transmission apparatus of claim 2, wherein the data generating unit includes:
a serial-to-parallel converter that performs the serial-to-parallel conversion on the transmission data transmitted from the transmission buffer according to the data transmission rate and converts them into N bits;
a first spreader that spreads the output from the serial-to-parallel converter using different spread codes according to the data transmission rate; and
a second spreader that spreads the output from the first spreader using a predetermined one spread code.

9. The frequency selective transmission apparatus of claim 1, wherein the pilot generating unit includes:
a pilot generator that uses a portion or all the preambles generated from the preamble generating unit as a pilot or generates the pilot having the same construction as the preamble and output values different from the preamble; and
a spreader that spreads the pilot generated from the pilot generator.

10. The frequency selective transmission apparatus of claim 1, further comprising a spreader that is connected to the output end of the multiplexer and spreads the output from the multiplexer using the predetermined one spread code.

11. A frequency selective transmission apparatus, comprising:
a preamble generating unit that generates a preamble for frame synchronization;
an SFD/RI generating unit that generates a start frame delimiter/rate indicator (SFD/RI) having a function of an indicator to announce the start of the frame and a function to define the transmission rates of header/data fields;
a header/data generating unit that transmits a header and data having a predetermined processing gain at the desired frequency band by spreading the header and the data including attribute information on transmission data in the same manner;
a pilot generating unit that generates a pilot inserted into the frame for frequency offset compensation;
a first multiplexer that receives and multiplexes outputs from the preamble generating unit, the SFD/RI generating unit, the header/data generating unit, and the pilot generating unit, respectively; and
a signal electrode that transmits the output from the first multiplexer into a human body.

12. The frequency selective transmission apparatus of claim 11, further comprising:
a transmission register that inputs a preamble construction value, an SFD/RI control value, and attribute information on the transmission data among data information transmitted from an upper layer, respectively, to the preamble generating unit, the SFD/RI generating unit, and a second multiplexer;
a transmission buffer that stores the transmission data transmitted from the upper layer and then inputs the transmission data to the second multiplexer at a predetermined time for each frame; and
a second multiplexer that multiplexes the transmission data and the attribute information on the input transmission data and inputs them to the header/data generating unit.

13. The frequency selective transmission apparatus of claim 11, further comprising an analog transmission processing unit that is connected to the output end of the first multiplexer, including at least one of a bandpass filter that limits the output from the first multiplexer to the desired frequency band and an amplifier that amplifies a final output signal.

14. The frequency selective transmission apparatus of claim 11, wherein the preamble generating unit includes:
a preamble generator that generates a preamble configured of pseudo noise codes or a repeated combination of the pseudo noise codes; and
a spreader that spreads a preamble generated from the preamble generator.

15. The frequency selective transmission apparatus of claim 11, wherein the SFD/RI generating unit includes:
an SFD/RI generator that generates the SFD/RI using the same pseudo noise code as that of the preamble generating unit or the pseudo noise code different from that of the preamble generating unit and defining the transmission rates of the header/data fields by assigning a time offset to the start of the pseudo noise code; and
a spreader that spreads the SFD/RI generated from the SFD/RI generator.

16. The frequency selective transmission apparatus of claim 12, wherein the header/data generating unit includes:
a serial-to-parallel converter that receives the output from the second multiplexer to perform serial-to-parallel conversion on the received output according to the data transmission rate and converts it into N bits; and
a frequency selective spreader that spreads the header/data serial-to-parallel converted by the serial-to-parallel converter using frequency selective spread codes positioned in the desired frequency band.

17. The frequency selective transmission apparatus of claim 11, wherein the pilot generating unit includes:
a pilot generator that uses a portion or all the preambles generated from the preamble generating unit as a pilot or generates the pilot having the same construction as the preamble and output values different from the preamble; and
a spreader that spreads the pilot, generated from the pilot generator.

18. The frequency selective transmission apparatus of claim 11, further comprising a spreader that is connected to the output end of the first multiplexer and spreads the output from the first multiplexer using the predetermined one spread code.
